(19) United States
(12) Patent Application Publication
(10) Pub. No.: US 2025/0326688 A1
(43) Pub. Date: Oct. 23, 2025

(54) QUARTZ-FREE COMPOSITE SURFACE

(71) Applicant: Stone Composite Surfaces, Inc., Tustin, CA (US)

(72) Inventor: Alexander Luis ALVAREZ, Tustin, CA (US)

(21) Appl. No.: 19/183,294

(22) Filed: Apr. 18, 2025

Related U.S. Application Data
(60) Provisional application No. 63/636,508, filed on Apr. 19, 2024.
(60) Provisional application No. 63/703,748, filed on Oct. 4, 2024.

(51) Int. Cl. C04B 14/22; C04B 14/30; C04B 22/14; C04B 26/06; C04B 40/02; C04B 103/00; C04B 111/10; C04B 111/54

(52) U.S. Cl. CPC C04B 14/22; C04B 14/303; C04B 22/142; C04B 26/06; C04B 40/0263; C04B 2103/0079; C04B 2111/1056; C04B 2111/542

(57) ABSTRACT

An engineered stone surface and method of forming engineered stone surfaces utilizing a glass/mineral mixture with a resin binder to form an engineered stone structure that is completely devoid of quartz (crystalline silica) to possess the visual aesthetics of natural quartzites.

### CROSS-REFERENCE TO RELATED APPLICATIONS

This application claims priority to U.S. Provisional Patent Application No. 63/636,508 filed on Apr. 19, 2024, and to U.S. Provisional Patent Application No. 63/703,748 filed on Oct. 4, 2024, the entire disclosures of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a method of forming an engineered stone surface structure, more specifically, to a method of forming a composite mix of mineral ingredients with a resin binder and a silane coupling agent to form an engineered glass/mineral structure that is completely devoid of quartz (crystalline silica). The quartz-free composite structure possesses the visual aesthetics of natural quartzites using barium sulfate powder and/or alumina (e.g., alumina trihydrate or ATH) powder and/or nano-glass powder and frit glass powder in place of quartz powder and using glass frit aggregate and low-iron glass (also referred to as super white glass) aggregate in place of quartz grit.

### 2. Description of the Related Art

Engineered stone may refer to a composite material comprised of crushed stone which may be bound together by an adhesive such as a resin binder. Examples of engineered stone may include quartz and feldspar, the two most prevalent minerals in the earth's crust. Engineered stone is commonly used in the construction industry, with quartz in particular finding particular appeal for use as kitchen and bath countertops.

Quartz has desirable structural, performance, and maintenance attributes that make it desirable for use in construction applications in place of natural stone, being stronger, harder, and more stain resistant than granite and marble. However, quartz surfacing lacks the strength required for use as thin format slabs (1.2-1.5 cm) for countertops without full underlayment support. Moreover, quartz lacks the translucency of onyx, the aesthetics of quartzite, and the white background of pure white marbles. In the United States, more than 70% of the quartz countertops used are in 3 cm thickness, and the remainder are in 2 cm thickness. There is a need for a thinner format for countertop applications that will consume less raw materials and reduce handling burden, resulting in reduced handling costs and installation costs as well as health & safety benefits for workers doing the handling and installation, while still providing the necessary structural strength for use as countertops. Furthermore, thin format slabs will enable use of conventional cutting tools such as ceramic tile cutting tools for cutting and fitting of countertops, thus avoiding additional work in the fabrication facility during installation. In addition, quartz raw materials needed to provide the aesthetics of premium natural white marbles and quartzites may need to be secured in various foreign countries, resulting in volatility in the overall cost of producing quartz products locally.

Health considerations with the fabrication of quartz slabs have recently resulted in a ban on the fabrication of artificial stone slabs containing quartz ingredients in Australia and heightened scrutiny in the United States. Crystalline silica (i.e., quartz) is OSHA regulated in the United States and is a common mineral found in materials such as natural stone, artificial stone, and sand. When workers cut, grind, and fabricate materials that contain crystalline silica, they can be exposed to very small dust particles (“respirable” particles) that can travel deep into the workers' lungs and cause silicosis, an incurable lung disease. It is additionally believed that prolonged exposure to respirable crystalline silica may also cause lung cancer.

In view of the market demand, there is a need for a quartz-free thinner slab format for countertops which can be lighter and more economical, while also meeting a demand for aesthetics that resemble premium white marbles and quartzite designs. Various aspects of the present disclosure address these needs, as will be discussed in more detail below.

### BRIEF SUMMARY

In recognizing these above-referenced deficiencies, the present inventor has employed methods of replacing quartz ingredients using fritted glass (also referred to as fritz glass) powder and nano-glass powder, alumina powder and barium sulfate powder to replace quartz powder, which is mixed with a resin to form a binder for glass frit and low-iron glass (also referred to as super white glass) aggregate. The recipe uses a resin content of 11-13% to bind the powder and aggregate and can be used to produce translucent white marble aesthetics. Natural white marble typically contains crystalline silica content of <10%. Natural quartzites by definition contain 80+% quartz (crystalline silica) and have a more opaque background and linear veins than white marble and typically have greater density due to their high quartz content.

The present disclosure specifically addresses the above drawbacks accompanying the related art and comprises a method of forming a glass/mineral composite mixture with a resin binder to form an engineered stone surface structure that is completely devoid of quartz (crystalline silica). The resulting quartz-free composite structure possesses the visual aesthetics of natural quartzites and possesses suitable strength for use in thin slab surface applications.

According to one embodiment, there is provided a quartz-free composite structure comprising glass aggregate, glass powder, barium sulfate powder, alumina powder, a resin binder, and a coupling agent, wherein the quartz-free composite structure is devoid of crystalline silica.

The glass aggregate may comprise glass frit. The glass aggregate may further comprise low-iron glass.

The glass aggregate may be in an amount 55-56% by weight of the composite structure.

The glass powder may comprise glass frit powder. The glass powder may further comprise nano-glass powder.

The glass powder may comprise nano-glass powder.

The glass powder may be in an amount 3-7% by weight of the composite structure.

The alumina powder may be in an amount 11-15% by weight of the composite structure.

The barium sulfate powder may be in an amount 12-15% by weight of the composite structure.

The resin binder may be in an amount 11-13% by weight of the composite structure.

The coupling agent may be in an amount 1-2% by weight of the composite structure.

According to another embodiment, there is provided an engineered stone comprising glass aggregate, glass powder, barium sulfate, alumina powder, a resin binder, and a coupling agent.

There is provided another method of manufacturing an engineered stone surface, with the method comprising pouring a mixture including glass aggregate, glass powder, barium sulfate, alumina powder, a resin binder, and a coupling agent into a mold; and compacting the mixture in the mold.

The method of may also include heating the compacted mixture in an oven.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic view of a process of manufacturing an engineering stone product.

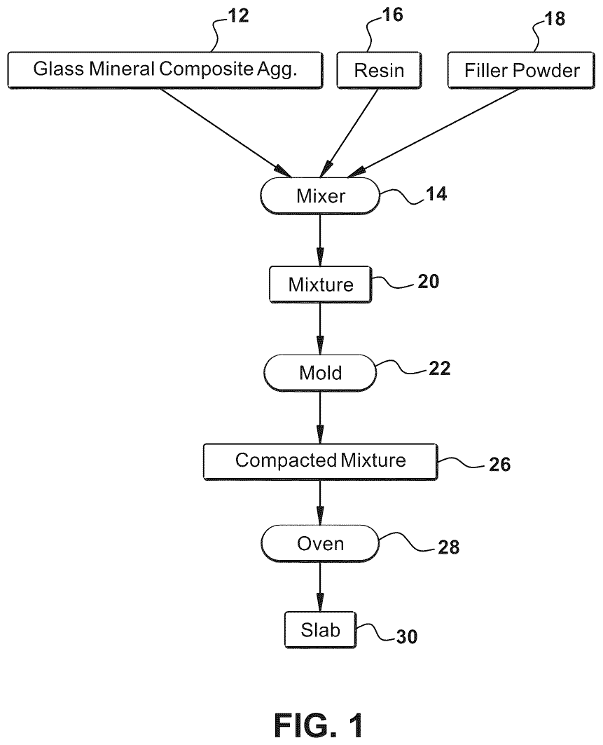

Common reference numerals are used throughout the drawings and the detailed description to indicate the same elements.

### DETAILED DESCRIPTION

The detailed description set forth below is intended as a description of certain embodiments of a glass/mineral composite structure, a slab formed therefrom, and a related method of forming the same and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

An exemplary formula for a glass/mineral composite structure that is completely devoid of quartz (crystalline silica) and enables the aesthetics of natural quartzites uses barium sulfate powder and/or alumina powder and/or fritted glass powder in place of quartz powder.

Barium sulfate is used as a densification powder in oil well drilling fluids as a filler for plastics to increase the density of the polymer, as well as in white pigment for paints to modify the consistency and increase opacity. Barium sulfate powder is insoluble in water. An exemplary formula of a glass/mineral composite ingredient mix including barium sulfate may be selected from the following ranges in the following table 1 to obtain desired aesthetics and performance properties:

TABLE 1

| Ingredient | Wt. % |
|---|---|
| glass frit aggregate and/or low-iron | 55-56% |
| (super white) glass aggregate | |
| (40-70 mesh*, 60-100 mesh) | |
| glass frit powder (325 mesh) and | 8-25% |
| nano-glass powder (325 mesh) | |
| alumina (400-600 mesh) | 3-15% |
| barium sulfate (625 mesh) | 5-12% |
| resin binder | 11.5-13% |
| coupling agent | 1-2% |

*Mesh refers to the number of squares per square inch of wire screen used to filter ingredients added to the mix. The larger the mesh, the larger the particle that can fit and pass through the wire screen.

The formula may include different amounts of the above ingredients and may omit some of the ingredients (or include additional ingredients), depending on the desired aesthetics and material properties. In general, the glass frit aggregate and/or low-iron glass aggregate may represent a majority of the weight of the composite structure, preferably 40-60%, while the frit glass powder may be in an amount 8-25% by weight of the composite structure. Alumina, if included, may preferably be in an amount 5-15% by weight, and barium sulfate may be in an amount, e.g., 5-12%. The resin binder may typically be 10-15%, while the coupling agent may be 1-2%.

The barium sulfate powder increases the packing density of the mix with minimal water absorption, increases the opacity for natural quartzite aesthetics, improves wear resistance, improves UV resistance and improves the stability of the veins for producing the linear veins of quartzites. The barium sulfate powder also acts as a whitening agent and titanium oxide pigment extender. The frit glass (fritz glass) powder, nano-glass powder and frit glass aggregate enhance scratch resistance and translucency. The alumina powder (aluminum trihydrate or ATH) provides whiteness and translucency. The glass aggregate component provides superior tensile strength and binds well with the resin binder. Nano-glass powder which may be used in place of fritted glass powder has a higher amorphous silica content, may be harder and increases the scratch resistance further but at a higher cost.

A method of manufacturing an engineered stone surface may begin with pouring the glass/mineral composite aggregate ingredient(s) 12 into a mixer 14 with the larger aggregate mixed first followed by the smaller aggregate. The resin 16 may then be poured into the mixer 14, and the filler powder (e.g., glass frit and/or nano-glass powder and/or alumina) 18 may afterwards be poured into the mixer 14. There may be a 2-minute time frame for mixing between the addition of each component, for example. The mix 20 is then poured into a mold 22. The compaction of the mixture in the mold 22 using a high viscosity resin binder with 1-2% silane coupling agent (preferably 1.2-2%) requires sufficient time during the compaction process for the resin to migrate through the mixture 20. The coupling agent improves the flex strength of the finished product. The compaction process time varies, but in the preferred embodiment, vibration is utilized during the compaction to allow the resin to migrate throughout the structure. The resin migration can further be improved by a multi-stage vibration compaction process which increases the compaction efficiency gradually to provide more time for the resin migration in early stages.

Subsequently, the method contemplates heating the compacted mixture 26 in an oven 28. The oven heating drives the reaction of the resin to bind the aggregate and form a slab 30 which can be polished into a finished surface product preferably having a 1.2-1.5 cm format, i.e., thickness, for countertops and walls. The slabs are preferably kept in an oven for 90-150 minutes to release internal stresses from the polymer reaction of the resin with the aggregate. The polymerization reaction is generally 95% complete after 25 minutes in the oven, and the remaining time may be used to cure the slabs and reduce stresses from the reaction so as to minimize bending of the slabs during cooling and storage prior to polishing. The slabs 30 are preferably stored flat on a metal rack for 24 hours after removal from the oven to keep the slabs 30 flat during cooling and before polishing.

As demonstrated by the following test results performed in accordance with ASTM International standards, a quartz-free slab as described herein may exhibit excellent performance properties making it suitable for a thin format (e.g., 1.2-1.5 cm) as shown in the following Table 2:

TABLE 2

| | IAPMO IGC 340-2017 | Quartz-free slab described |
|---|---|---|
| | Quartz Surfacing Standard | herein |
| Izod Impact Test | N/A | 95.90 J/m |
| ASTM D-256 | | (average of ten samples having an |
| | | average thickness of 10.79 mm) |
| Flexural Strength | >34.5 MPa | 70 MPa |
| Test | | (average of five samples having |
| ASTM C880 (Wet) | | an average thickness of 12.22 |
| | | mm) |
| Flexural Strength | >34.5 MPa | 61 MPa |
| Test | | (average of five samples having |
| ASTM C880 (Dry) | | an average thickness of 12.03 |
| | | mm) |
| Stain Resistance | N/A | Pass |
| IAPMO Z124 | | |
| Water Absorption | <0.10% | 0.03% |
| ASTM C97 | | (average of three samples) |
| Density | N/A | 2.30 g/cm³ |
| ASTM C97 | | (average of three samples) |
| Abrasion Resistance | N/A | 0.032 mg/cycle |
| ASTM C501 | | (average of three samples) |
| (weight loss by | | |
| revolution using | | |
| Taber 5130 Abraser) | | |

As can be seen from Table 2, the disclosed quartz-free slab demonstrates excellent performance suitable for thin formats, exceeding relevant International Association of Plumbing and Mechanical Officials (IAPMO) industry standards. In addition, results of the Izod Impact Test and Flexural Strength Tests far exceeded typical reported scores of quartz slabs on the market today, with the disclosed quartz-free slab achieving an Izod Impact Test result of 95.90 J/m in comparison to 13.3 J/M or 18.8 J/M of typical quartz slabs, and with the disclosed quartz-free slab achieving Flexural Strength Test results of 70 MPa (wet) and 61 MPa (dry) in comparison to 38.8 MPa (wet) and 53.3 MPa (dry) of typical quartz slabs.

In addition to the foregoing, it is contemplated that a silica-free composite surface can be produced wherein the majority ingredients are resin (15%), alumina (70-75%) and barium sulfate powder (10-15%). This formula may not require fabrication in wet fabrication equipment and may be done using panel saws and routers with carbide tooling used dry with solid surface and wood. Alumina is not regulated by OSHA. Furthermore, fabrication costs with solid surface are typically 40-50% below costs with wet fabrication equipment for stone and quartz.

Frit glass in the range of 10%-20% will add 6-12% amorphous silica and provide more scratch resistance to the composite surface while maintaining a low silica formula that can be fabricated with dry equipment for solid surface and produced in slab manufacturing equipment.

The ingredients formulas may include different amounts of the above ingredients and, in some implementations, may omit some of the ingredients (or include additional ingredients), depending on the desired aesthetics and material properties. The Mineral Composite Surface can provide a range of properties using the properties and aesthetics of the various mineral ingredients to achieve the desired performance and aesthetics for the intended use.

As an example, the application may require outdoor use with UV resistance properties provided by 10% barium sulfate and ISO acrylic resin binder (vs. polyester). An exemplary formula provided <0.2 Delta E in 100 hours of Light Aging test for UV exposure which is less than the difference a naked eye can detect. The packing density may be enhanced by alumina and barium powder to increase impact resistance. Superwhite glass may be used together with the binding resin to increase flex strength.

The composite of the various mineral ingredients which have replaced quartz provide a range of properties not achieved with quartz while also providing a crystalline silica-free surface.

The above description is given by way of example, and not limitation. Given the above disclosure, one skilled in the art could devise variations that are within the scope and spirit of the invention disclosed herein, including various ways of creating the dry mix. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A quartz-free composite structure comprising:
glass aggregate;
glass powder;
barium sulfate powder;
alumina powder;
a resin binder; and
a coupling agent,
wherein the quartz-free composite structure is devoid of crystalline silica.

2. The quartz-free composite structure of claim 1, wherein the glass aggregate comprises glass frit.

3. The quartz-free composite structure of claim 2, wherein the glass aggregate further comprises low-iron glass.

4. The quartz-free composite structure of claim 1, wherein the glass aggregate is in an amount 55-56% by weight of the composite structure.

5. The quartz-free composite structure of claim 1, wherein the glass powder comprises glass frit powder.

6. The quartz-free composite structure of claim 5, wherein the glass powder further comprises nano-glass powder.

7. The quartz-free composite structure of claim 1, wherein the glass powder comprises nano-glass powder.

8. The quartz-free composite structure of claim 1, wherein the glass powder is in an amount 3-7% by weight of the composite structure.

9. The quartz-free composite structure of claim 1, wherein the alumina powder is in an amount 11-15% by weight of the composite structure.

10. The quartz-free composite structure of claim 1, wherein the barium sulfate powder is in an amount 12-15% by weight of the composite structure.

11. The quartz-free composite structure of claim 1, wherein the resin binder is in an amount 11-13% by weight of the composite structure.

12. The quartz-free composite structure of claim 1, wherein the coupling agent is in an amount 1-2% by weight of the composite structure.

13. An engineered stone comprising:
glass aggregate;
glass powder;
barium sulfate;
alumina powder;
a resin binder; and
a coupling agent.

14. The engineered stone of claim 13, wherein the glass aggregate comprises glass frit.

15. The engineered stone of claim 14, wherein the glass aggregate further comprises low-iron glass.

16. The engineered stone of claim 13, wherein the glass powder comprises glass frit powder.

17. The engineered stone of claim 13, wherein the alumina is in an amount 11-15% by weight of the engineered stone.

18. The engineered stone of claim 13, wherein the barium sulfate is in an amount 12-15% by weight of the engineered stone.

19. A method of manufacturing an engineered stone surface, the method comprising:
pouring a mixture including glass aggregate, glass powder, barium sulfate, alumina powder, a resin binder, and a coupling agent into a mold; and
compacting the mixture in the mold.

20. The method of claim 19, further comprising heating the compacted mixture in an oven.
